(19) United States
(12) Patent Application Publication
(10) Pub. No.: US 2024/0265139 A1
(43) Pub. Date: Aug. 8, 2024

(54) METHOD AND SYSTEM FOR PRIVACY MULTI-TIERING OF AUTOMOTIVE DATA

(71) Applicant: OTONOMO TECHNOLOGIES LTD., Herzeliya Pituach (IL)

(72) Inventor: Yosef Haim ITZKOVICH, Raanana (IL)

(73) Assignee: OTONOMO TECHNOLOGIES LTD., Herzeliya Pituach (IL)

(21) Appl. No.: 18/165,528

(22) Filed: Feb. 7, 2023

(51) Int. Cl. G06F 21/62; G06F 21/78

(52) U.S. Cl. CPC G06F 21/6254; G06F 21/78; G06F 2221/2113

(57) ABSTRACT

A method and a system for multi-tiering of automotive data for complying with privacy regulations are provided herein. The method may include the following steps: receiving a plurality of processed automotive data records; simultaneously storing the data records on three different data tiers in a data store based on privacy tiering rules; managing the data records on the data tiers responsive to ongoing revocation of consent for some of the data records; and providing data records to approved data consumers based on queries in accordance with the privacy tiering rules. The system may implement the method over a server in a client-server configuration.

### FIELD OF THE INVENTION

The present invention relates generally to the field of processing data features, and more particularly to processing data features affiliated with connected vehicles.

### BACKGROUND OF THE INVENTION

Prior to setting forth the background of the invention, it may be helpful to provide definitions of certain terms that will be used hereinafter.

The term “connected vehicle” as used herein is defined as a vehicle such as a car or any other vehicle such as an aerial vehicle that is equipped with any form of wireless network connectivity access, and usually also with a wireless local area network. This allows the connected vehicle to share internet access with other devices both inside as well as outside the vehicle.

The term “data marketplace” or “data market” as used herein is defined as an online platform that enables a plurality of users (subscribers) to access and consume data. Data marketplaces typically offer various types of data for different markets and from different sources. Common types of data consumers include business intelligence, financial institutions, demographics, research and market data. Data types can be mixed and structured in a variety of ways. Data providers may offer data in specific formats for individual clients.

Data consumed in these marketplaces may be used by businesses of all kinds, fleets, business and safety applications and many types of analysts. Data marketplaces have proliferated with the growth of big data, as the amount of data collected by municipalities and smart cities, businesses, websites and services has increased, and all that data has become increasingly recognized as an asset.

The term “data anonymization” as used herein is defined as type of information sanitization whose intent is privacy protection. It is the process of either encrypting or removing personally identifiable information from data sets, so that the people and other entities whom the data describe remain anonymous.

When storing data entries in to a storage it is sometimes desirable to store the data records simultaneously on more than one storage device per type of data record. Known types of storage currently available is multi-tier storage with different performance and latency usually combining different types of hardware magnetic disks and SSD.

### SUMMARY OF THE INVENTION

When data records are subject to privacy regulation such as the GDPR, retaining the data on the data storage is subject to the ongoing consent of the data owners. Once consent is revoked, there is a time limited period during which the data should be erased.

In accordance with some embodiments of the present invention it is being suggested to provide an alternative approach for tiering that instead of using different storage types of storage devices, preserves privacy of the data owners in a multi-tiered manner that reflects the various use cases for the data consumption. Each tier on the multi-tiered data store should have different level of retention which is supposed to serve different type of privacy requirements and optimally cover serving both anonymous and private data storing.

In accordance with some embodiments of the present invention, every data record that is being ingested into the system shall be stored in three different tiers, so it can serve multiple use cases, and still support a user option to revoke access of his or her data from the system.

Advantageously, by using the privacy tiered data store of the present invention, the right to be forgotten can be implemented in “order one” being O(1) in terms of latency which is a major improvement over currently available implementations.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating non-limiting exemplary architecture of a marketplace server for managing data relating to connected-cars in accordance with embodiments of the present invention; and

FIG. 2 is a high-level flowchart illustrating non-limiting exemplary method in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing” “computing” “calculating” “determining” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

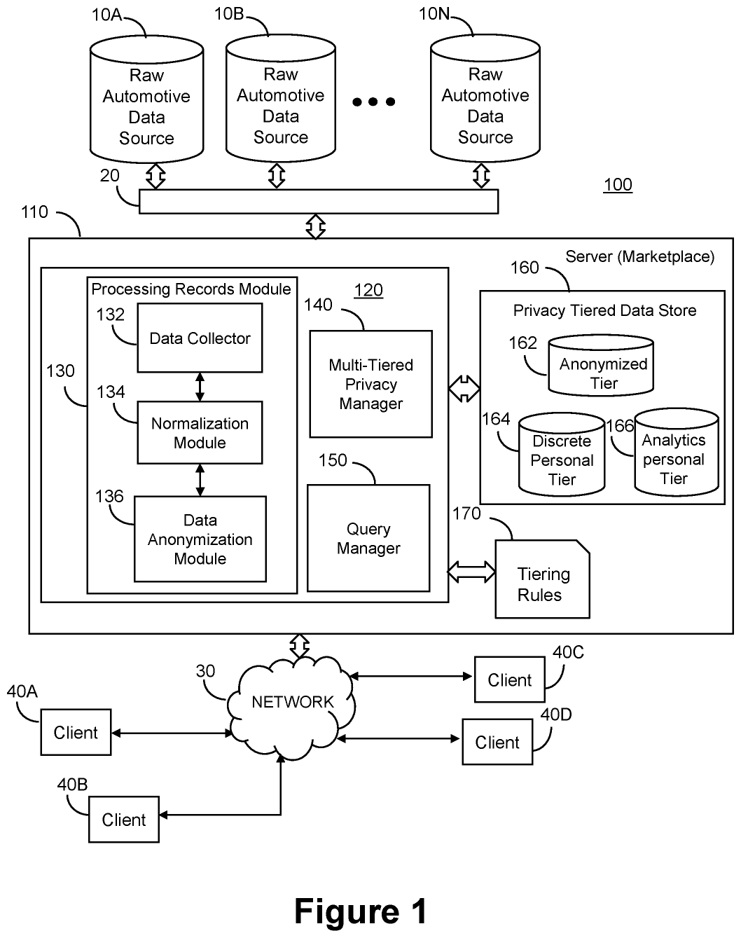

FIG. 1 is a block diagram illustrating non-limiting exemplary architecture of a system 100 capable of detecting a driver detachment from a vehicle and gradually limiting the access to data related to that vehicle, as a part of a data marketplace. The system may include: a server 120 configured to obtain a plurality of data features relating to connected vehicles originated from a plurality of data sources 110. System 100 may include a server 110 implementing the data marketplace and connected via network 30 to a plurality of clients 40A-40D. Vehicle related data, possibly obtained for various sensors may be stored in raw format on a plurality of vehicle related data sources 10A-10N and are accessed by server 110 via a secured data link 20. Server 110 may include a processing records module 130 implemented by a computer readable code running on computer processor 120. Processing records module 130 may include a data collector 132, a normalization module 134 and a data anonymization module that are configured to collect, normalize and anonymize respectively the data arriving from the plurality of vehicle related data sources 10A-10N, thus creating a privacy tiered data store 160 storing vehicle related data. The processed records are being consumed and used by various data services modules 140 implemented by a computer code running on computer processor 120 on server 110 responsive to various requests from plurality of clients 40A-40D.

Server 110 may further include multi-tiered privacy manager 140 implemented by computer codes running on computer processor 120. Multi-tiered privacy manager 140 may be configured to simultaneously store new data records arriving from processing records module 130 onto three different tiers 162, 164, and 166 on privacy tiered data store 160 in accordance to tiering rules 170.

According to some embodiments of the present invention, server 110 may further include a query manager 150 implemented by computer code running on computer processor 120. Query manager 150 may be configured to receive data queries from plurality of clients 40A-40D and retrieve the data records from the appropriate one of tiers 162, 164, and 166.

Following are the three privacy tiers in accordance with embodiments of the present invention:

### Anonymized Tier

In accordance with some embodiments of the present invention, anonymized tier 162 save all historical data after passing anonymization via data anonymization module 136. The data is saved plain without encryption and is never deleted. It has the following characteristics:
1. High retention
2. Access pattern/use case: This is anonymized data so only analytics and aggregation by definition. There is no sense of discrete (specific) access.
3. Store type/format: Probably some kind of data lake.
4. No revoke access needed as its anonymous so no user.
5. No extrinsic event that necessitates erasure.

### Discrete Personal Tier

In accordance with some embodiments of the present invention, discrete personal tier 164 save all historical data after passing anonymization via data anonymization module 136.

The data is saved plain without encryption and is never deleted. It has the following characteristics:
1. High/Medium (historical/e.g. 1 year) retention. Depends on requirements—the retention may have effect on the store type and performance.
2. Discrete access without aggregation (or comparison). When talking about a large set it is very hard in practice and will require retrieving keys and decrypting large amount of data.
3. Ingestion process and revoke procedure:
   encrypted with different key per entity.
   A table with a key per user is saved at the side, with key versioning
   All fields are encrypted except the id, key version
   Each record has a tag of encryption key
   Once a user request to revoke access—the key is simply deleted and there is basically no need to do anything else as the data is now inaccessible.

### Analytics Personal Tier

In accordance with some embodiments of the present invention, analytics personal tier 166 save all fields of the data records with the following characteristics:
1. Short retention, K days retention (30 days e,g).
2. Data is saved in plain mode no encryption.
3. Every time an entity requests to be removed it gets into a black list which stops storing its data and all its data will be evicted in K days. So, no active action upon revoke just stop adding new data and the eviction will happen by design.
4. Support discrete access of K days history+analytics & aggregation

Instead of actual erasure but using different keys per entries the system “forgets” an entry very quickly by encrypting it with a key as soon as the respective key is deleted.

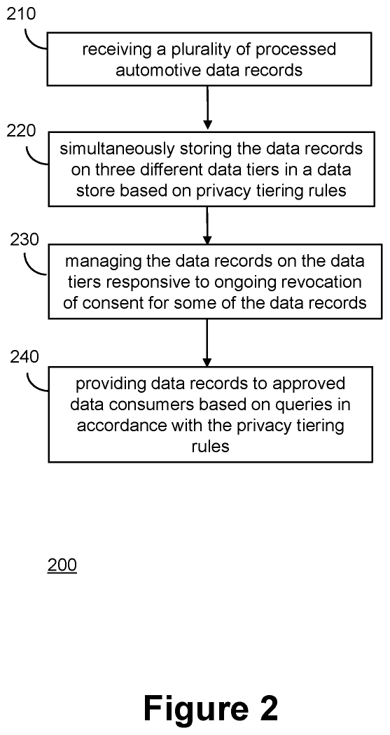

FIG. 2 is a high-level flowchart illustrating non-limiting exemplary method in accordance with embodiments of the present invention. A method 200 of multi-tiering of automotive data for complying with privacy regulations is provided herein. Method 200 may include the following steps: receiving a plurality of processed automotive data records 210; simultaneously storing the data records on three different data tiers in a data store based on privacy tiering rules 220; managing the data records on the data tiers responsive to ongoing revocation of consent for some of the data records 230; and providing data records to approved data consumers based on queries in accordance with the privacy tiering rules 240.

It should be noted that method 200 according to embodiments of the present invention may be stored as instructions in a computer readable medium to cause processors, such as central processing units (CPU) to perform the method. Additionally, the method described in the present disclosure can be stored as instructions in a non-transitory computer readable medium, such as storage devices which may include hard disk drives, solid state drives, flash memories, and the like. Additionally, non-transitory computer readable medium can be memory units.

In order to implement the method according to embodiments of the present invention, a computer processor may receive instructions and data from a read-only memory or a random-access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, JavaScript Object Notation (JSON), C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of multi-tiering of automotive data for complying with privacy regulations, the method comprising:
receiving a plurality of processed automotive data records;
simultaneously storing the data records on one or more out of three or more different data tiers in a data store based on privacy tiering rules;
managing the data records on the data tiers responsive to ongoing revocation of consent for some of the data records; and
providing data records to approved data consumers based on queries in accordance with the privacy tiering rules.

2. The method according to claim 1, wherein said three different data tiers comprise: an anonymized data tier; a discrete personal tier; and an analytics data tier.

3. The method according to claim 2, wherein the data records on the anonymized data tier are fully anonymized, the data on the discrete personal are anonymized via a key and the analytics data tier are not anonymized.

4. The method according to claim 3, wherein the data records on the anonymized data tier are have long term data retention, the data on the discrete personal are anonymized via a key and the analytics data tier have a short-term data retention.

5. A system of multi-tiering of automotive data for complying with privacy regulations, the method comprising:
a data records processing module configured to receive a plurality of processed automotive data records; and
a multi-tiered privacy manager configured to:
simultaneously storing the data records on one or more out of three or more different data tiers in a data store based on privacy tiering rules;
manage the data records on the data tiers responsive to ongoing revocation of consent for some of the data records; and
provide data records to approved data consumers based on queries in accordance with the privacy tiering rules.

6. The system according to claim 5, wherein said three different data tiers comprise: an anonymized data tier; a discrete personal tier; and an analytics data tier.

7. The system according to claim 6, wherein the data records on the anonymized data tier are fully anonymized, the data on the discrete personal are anonymized via a key and the analytics data tier are not anonymized.

8. The system according to claim 7, wherein the data records on the anonymized data tier are have long term data retention, the data on the discrete personal are anonymized via a key and the analytics data tier have a short-term data retention.

9. A non-transitory computer readable medium for multi-tiering of automotive data for complying with privacy regulations, the computer readable medium comprising a set of instructions that when executed cause at least one computer processor to:
receive a plurality of processed automotive data records; and
simultaneously store the data records on three different data tiers in a data store based on privacy tiering rules;
manage the data records on the data tiers responsive to ongoing revocation of consent for some of the data records; and
provide data records to approved data consumers based on queries in accordance with the privacy tiering rules.

10. The non-transitory computer readable medium according to claim 9, wherein said three different data tiers comprise: an anonymized data tier; a discrete personal tier; and an analytics data tier.

11. The non-transitory computer readable medium according to claim 10, wherein the data records on the anonymized data tier are fully anonymized, the data on the discrete personal are anonymized via a key and the analytics data tier are not anonymized.

12. The non-transitory computer readable medium according to claim 11, wherein the data records on the anonymized data tier are have long term data retention, the data on the discrete personal are anonymized via a key and the analytics data tier have a short-term data retention.
